(19) United States
(12) Patent Application Publication
(10) Pub. No.: US 2026/0171863 A1
(43) Pub. Date: Jun. 18, 2026

(54) OUTER ROTOR TYPE MOTOR

(71) Applicant: SHINANO KENSHI KABUSHIKI KAISHA, Nagano (JP)

(72) Inventor: Shun TAKAYAMA, Nagano (JP)

(21) Appl. No.: 19/381,871

(22) Filed: Nov. 6, 2025

(30) Foreign Application Priority Data
Dec. 16, 2024 (JP) 2024-219547

(51) Int. Cl. H02K 5/173; F04D 17/08; F04D 25/06; F16C 19/18; H02K 21/22

(52) U.S. Cl. CPC H02K 5/1735; F04D 17/08; F04D 25/06; F16C 19/181; H02K 21/22; F16C 2380/26

(57) ABSTRACT

The bearing housing is press-machined in the radial direction to provide upper and lower bulging portions and that define axial positions of rolling bearings and bulge inward into a tubular bore at a plurality of positions in the circumferential direction. A housing accommodation part of a resin housing that covers the bearing housing has relief recesses formed at positions corresponding to the lower bulging portions.

### CROSS-REFERENCE TO RELATED APPLICATION

This application is based upon and claims the benefit of priority of the prior Japanese Patent Application No. 2024-219547, filed on Dec. 16, 2024, and the entire contents of which are incorporated herein by reference.

### TECHNICAL FIELD

The present disclosure relates to an outer rotor type motor used as a driving source for a vehicle-mounted device or an HVAC (Heating, Ventilation, and Air Conditioning) device, for example.

### BACKGROUND ART

As one example, in an outer rotor-type axial fan motor, rolling bearings that rotatably support a rotor shaft of a rotor to which a centrifugal fan is attached are expected to be quiet in operation and have a long lifespan. A bearing housing has a pair of rolling bearings fitted into the tubular bore of a metal tube and a stator unit (or “stator assembly”) assembled on the outer circumference of the tube. Since the motor needs to be assembled with both the rolling bearings centered and the stator assembly centered on the bearing housing, a high degree of roundness is required. Additionally, to reduce the manufacturing man-hours and cost, a product has been proposed in which a bearing housing in the form of a metal tube is manufactured by press machining, not by cutting, and is then insert-molded into a motor housing made of resin, which streamlines the assembly process (see Patent Document 1: Japanese Patent No. 4,461,311).

### SUMMARY OF INVENTION

### Technical Problem

In the configuration in Patent Document 1 described above, bearing holders (or “upper protrusions” and “lower protrusions”) are formed by press forming a bearing housing (or “bearing liner”), which is in the form of a metal tube, so as to protrude toward the inner periphery. Insert molding is then performed with the bearing housing as an insert. During molding, when the housing is clamped near the bearing holders inside the molding die, there is the risk of physical distortion that occurs near the bearing holders due to the press forming creating gaps between the bearing housing and the mold die, which can lead to resin leaking out through the gaps during molding to produce resin burrs.

In Patent Document 1, the bearing liner is formed by press machining a metal sheet material while feeding the material into a progressive die. When doing so, upper protrusions and lower protrusions formed by a cutting and raising process become disposed at unequal angles around the circumference of the bearing liner and the upper protrusions and lower protrusions will be in an inverted arrangement in the axial direction. This results in the risk of stress distortion around the entire circumference of the bearing liner and a potential drop in the roundness of the bearing liner which is in the form of a metal tube. In addition, since a small-diameter annular flange and notches in the flange are formed at one end of the bearing liner by a punching process that follows the cutting and raising process, there has also been the risk of distortion in the roundness of the inner diameter of the tubular bore of the bearing liner. Since the flange has a small diameter, there is a manufacturing issues in that the bearing liner is vulnerable to becoming dislodged in the axial direction of the bearing liner and to freely rotating during insert molding.

### Solution to Problem

The embodiments described below were conceived to solve the problem stated above and have an object of providing an outer rotor type motor which prevents the production of resin burrs on a bearing housing, which is in the form of a metal tube formed by press-machining and is insert-molded into a resin housing, has a bearing housing with a high degree of roundness, and has improved centering accuracy for components such as a pair of rolling bearings that are concentrically assembled in a tubular bore of the bearing housing and a stator assembly that is concentrically assembled on an outer circumference of the bearing housing.

To achieve the object stated above, the embodiment described below has the following configuration. An outer rotor type motor according to an aspect of the present disclosure includes: a stator on which stator poles are formed; a rotor on which rotor poles composed of a permanent magnet are disposed radially outside the stator to face the stator poles; a rotor shaft whose shaft end portion is integrally assembled with a hub of a rotor yoke, which is cup-shaped; a bearing housing shaped as a metal tube that is erected on and insert molded into a resin housing; and a pair of rolling bearings which are assembled inside the bearing housing and rotatably support the rotor shaft, wherein the bearing housing is press formed in the radial direction to provide upper bulging portions and lower bulging portions, which bulge inward into a tubular bore at a plurality of positions in the circumferential direction and define positions in the axial direction of the rolling bearings, and a tubular part of the resin housing that covers the bearing housing has relief recesses formed at positions corresponding to the lower bulging portions. By doing so, since the bearing housing in the form of a metal tube is insert-molded into the resin housing that has relief recesses formed in a tubular part corresponding to the lower bulging portions whose radial dimension is lacking in precision, the bearing housing can be fitted into the mold die at parts where the radial dimension is precise, thereby suppressing the production of resin burrs during insert molding.

The upper bulging portions and the lower bulging portions are preferably formed at corresponding positions along the axial direction that are equally spaced positions in the circumferential direction of the bearing housing. By doing so, since the upper bulging portions and the lower bulging portions are formed with the same phase around the bearing housing, stress distortion around the entire circumference is reduced and the roundness of the bearing housing in the form of a metal tube can be maintained even when press machining is performed in the radial direction.

The bearing housing preferably has an annular flange portion formed at an erection base end of a tubular part, the flange portion having a larger diameter than the tubular part, and notch parts, into which the resin of the resin housing flows, are preferably formed in an outer circumferential edge of the annular flange portion at a plurality of positions in the circumferential direction. In this way, since the bearing housing has an annular flange portion, which has a larger diameter than the tubular part, formed at the erection base end of the tubular part and a plurality of notch parts into which resin flows are formed in the outer circumferential edge of the annular flange portion, it is possible to maintain the roundness of the inner diameter of the tubular bore of the bearing housing, making it difficult for the bearing housing to be dislodged in the axial direction from the resin housing after insert molding and preventing the bearing housing from freely rotating.

### Advantageous Effects of Invention

According to an aspect of the present disclosure, there is provided an outer rotor type motor which prevents the production of resin burrs on a bearing housing, which is in the form of a metal tube formed by press-machining and is insert-molded into a resin housing, has a bearing housing with a high degree of roundness, and has improved centering accuracy for components such as a pair of rolling bearings that are concentrically assembled into a tubular bore of the bearing housing and a stator assembly that is concentrically assembled on an outer circumference of the bearing housing.

### BRIEF DESCRIPTION OF DRAWINGS

FIG. 1 is a perspective view of a centrifugal blower.

FIG. 2 is a perspective view of a state where a top housing of the centrifugal blower appearing in FIG. 1 has been removed.

FIG. 3 is a vertical cross-sectional view of principal parts of the centrifugal blower appearing in FIG. 1.

FIG. 4 is an enlarged cross-sectional view of a motor part in FIG. 3.

FIG. 5A is a perspective view of mated parts of a rolling bearing and a motor housing, and FIG. 5B is an enlarged perspective view of the mated parts.

FIG. 6A is a perspective view of a bearing housing and FIG. 6B is a plan view of the bearing housing.

### DESCRIPTION OF EMBODIMENTS

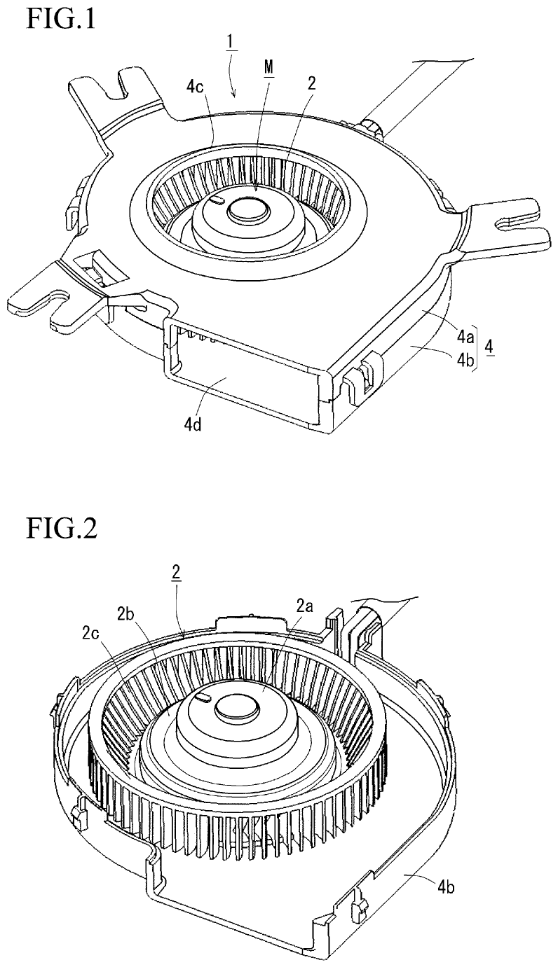

An embodiment of an outer rotor type motor according to the present disclosure is described below with reference to the accompanying drawings. First, the overall configuration of the outer rotor type motor will be described with reference to FIGS. 1 to 6. As one example, an outer rotor type motor M described here is a DC brushless motor used in a vehicle-mounted device. In the following description, a centrifugal blower 1 that uses the outer rotor type motor M as a driving source is described as an example.

In FIG. 1, the centrifugal blower 1 includes a centrifugal fan 2 and a rotor 3 that are integrally assembled, with the outer rotor type motor M that rotationally drives such components housed inside a blower housing 4 (or “resin housing”). In FIG. 2, the blower housing 4 is formed by assembling a top housing 4a that is assembled to cover the centrifugal fan 2 and a bottom housing 4b that rotatably supports the outer rotor type motor M (that is, the rotor 3 and a stator 5). An intake opening 4c is provided in the center of the top housing 4a, and air that is drawn in through this intake opening 4c and pressurized from the outside in the radial direction is expelled through an exhaust port 4d provided around the circumferential direction.

In FIG. 2, the centrifugal fan 2 includes a hub 2a integrally assembled with a rotor yoke 3a at the center in the radial direction. The centrifugal fan 2 is insert-molded with the rotor yoke 3a, with an upper surface portion of the rotor yoke 3a integrated with the hub 2a. A main plate 2b, which is continuous with the hub 2a, extends radially outward in a stepped form, and a plurality of impellers 2c, which are curved from the inside to the outside in the radial direction, are formed so as to be erected on this main plate 2b.

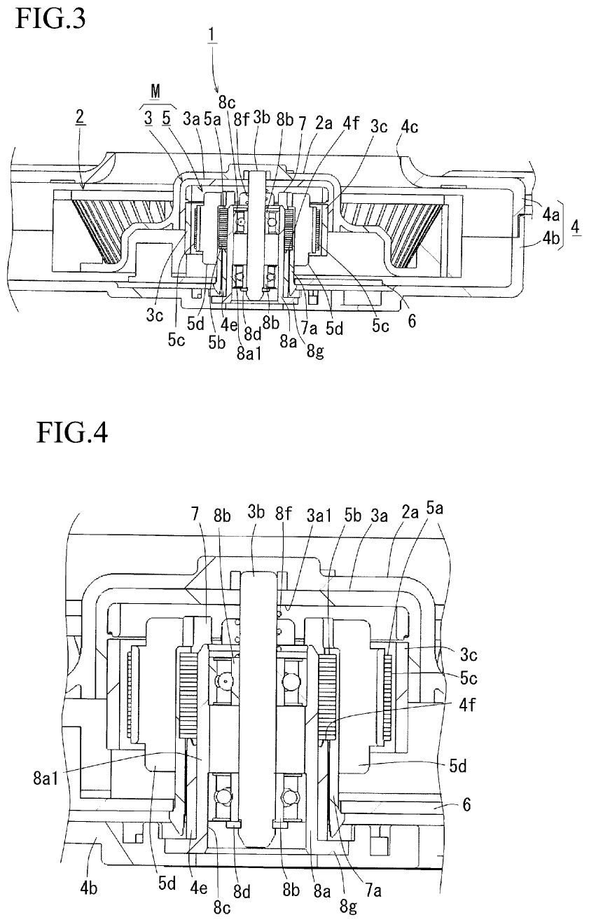

As depicted in FIG. 3, the outer rotor type motor M includes the rotor 3 and the stator 5. The rotor 3 includes a rotor shaft 3b attached to a hub of the rotor yoke 3a, which is cup-shaped. An annular rotor magnet 3c is provided on an inner circumferential surface of the rotor yoke 3a. The rotor magnet 3c is formed with rotor poles made of a permanent magnet that is magnetized with alternating north and south poles around the circumferential direction. The rotor 3 is assembled radially outside the stator 5 so that the rotor poles of the rotor magnet 3c face stator poles.

In FIG. 3, the stator 5 includes a plurality of pole teeth 5c that protrude radially outward from a core back part 5b of a stator core 5a, which is annular, with motor coils 5d being wound around these pole teeth 5c via an insulator 7 to form the stator poles. Although a single-phase coil is wound in the present embodiment, a three-phase coil or the like may also be used. The insulator 7 is also equipped with coil pins (not illustrated) at two locations that connect to a motor coil 5d. Coil leads that extend from the motor coil 5d are connected to the coil pins.

In FIG. 3, a bearing housing 8a in the form of a metal tube is insert-molded into the bottom housing 4b of the blower housing 4 and is concentrically assembled into a housing accommodation part 4e (or “tubular part”) which is also tubular. An upper end 4f of the housing accommodation part 4e determines the assembly position of the stator core 5a (the core back part 5b) in the axial direction. The bearing housing 8a is formed with a tubular part 8a1 and an annular flange portion 8g at a lower end of the tubular part 8a1 that has a larger diameter than the tubular part 8a1. A pair of rolling bearings (or simply “bearings 8b”) are assembled by being inserted into the tubular bore of the bearing housing 8a at both ends in the length direction of the bearing housing 8a. The positions in the axial direction of the pair of bearings 8b inside the tubular bore 8c are determined by a plurality of bulging portions, which will be described later. The rotor shaft 3b is rotatably supported by the pair of bearings 8b that are assembled inside the tubular bore 8c of the bearing housing 8a. A retaining washer 8d is fitted onto a shaft end of the rotor shaft 3b, which restricts axial movement by the bearing 8b at the lower end in the axial direction. The bearing housing 8a, which is assembled so as to be erected on the bottom housing 4b is provided with an annular flange 8g, whose diameter is larger than the diameter of the tubular part 8a1, at a base end thereof. As described later, the annular flange 8g is insert-molded to prevent the bearing housing 8a from coming out or rotating relative to the bottom housing 4b.

In FIG. 3, the motor substrate 6 is assembled on the blower housing 4 (the bottom housing 4b). Coil pins (not illustrated) that connect to the motor coils 5d wound around the pole teeth 5c of the stator core 5a are inserted into and soldered to substrate terminal holes. The motor substrate 6 is provided with a magnetic pole detection element (not illustrated), such as a Hall IC, for detecting magnetic pole positions of the rotor 3. The magnetic pole detection element detects magnetic pole positions of the rotor 3 and switches the direction of current flowing through the motor coil 5d, thereby causing the rotor 3 to rotate. Note that in a sensorless motor, the magnetic pole detection element may be omitted.

As depicted in FIG. 3, the stator core 5a is assembled on the insulator 7 by integral molding. The insulator 7 is formed by insert molding the stator core 5a using PBT (polybutylene terephthalate) resin, for example. Note that it is also possible to mold the insulator 7 separately and then assemble the insulator 7 in the periphery of the pole teeth 5c of the stator core 5a without using insert molding.

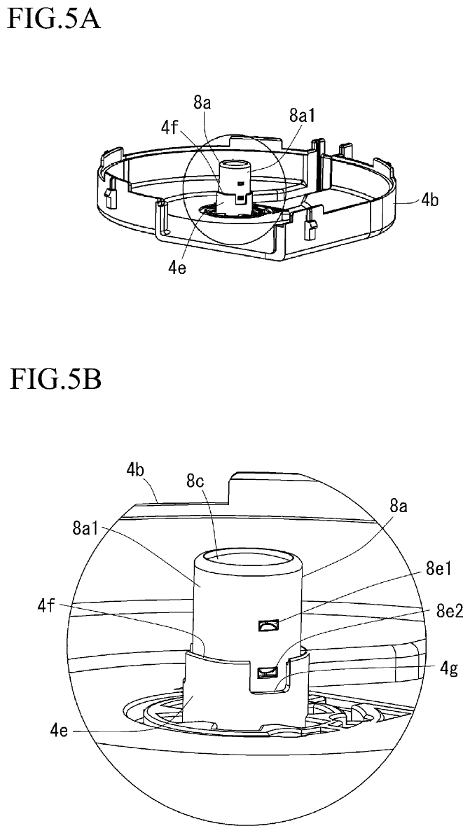

Tubular parts 7a are erected on both sides in the axial direction at positions radially inside the stator core 5a of the insulator 7. As described below, the motor substrate 6 is assembled onto one of these tubular parts 7a (see FIG. 4). The stator 5 and the motor substrate 6 (or “stator assembly”) are assembled onto the bottom housing 4b by concentrically fitting the tubular part 7a onto the outer circumference of the housing accommodation part 4e, which houses the bearing housing 8a that is in the form of a metal tube (see FIG. 2).

As one example, the bearing housing 8a is formed into a metal tube by transfer forming, in which a galvanized steel sheet is used as a base material (or “workpiece”) and is press-machined while being transported between press dies. When doing so, upper bulging portions 8e1 and lower bulging portions 8e2 that bulge inwardly into the tubular bore 8c of the tubular part 8a1 are provided at a plurality of positions in the circumferential direction (here, three positions at 120-degree intervals around the circumference). The upper bulging portions 8e1 and the lower bulging portions 8e2 determine the positions in the axial direction of the pair of bearings 8b that are fitted from both ends into the tubular bore 8c of the bearing housing 8a. The bearing housing 8a is insert-molded into the bottom housing 4b to become concentrically assembled on the bottom housing 4b with the lower half of the tubular part 8a1 covered by the housing accommodation part 4e (or “tubular part”). Note that although the upper half of the tubular part 8a1 of the bearing housing 8a is exposed from the housing accommodation part 4e, as depicted in FIG. 4, the stator assembly is assembled with the stator core 5a fitted onto the outer circumference of the upper half of the tubular part 8a1 and the core back portion 5b abutting the upper end 4f of the housing accommodation part 4e. In addition, to increase the rotational stability of the rotor 3, a preloading spring 8f is fitted onto the circumference of the rotor shaft 3b between the hub 3a1 of the rotor yoke 3a and the (inner ring of the) bearing 8b that is at the upper end in the axial direction and is disposed opposite to the hub 3a1 in the axial direction, in a state where the preloading spring 8f is compressed from its equilibrium length.

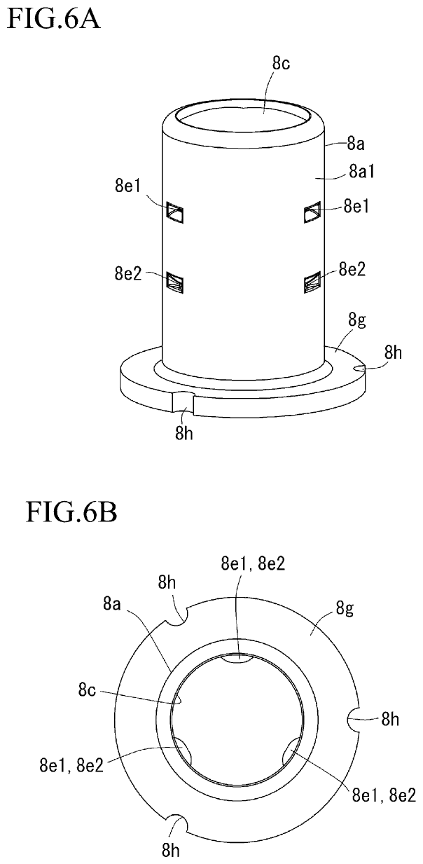

Note that one example of a press machining process for the bearing housing 8a is as follows. A workpiece (for example, a galvanized steel sheet) that serves as the base material is transported between a plurality of press die apparatuses and subjected to transfer press forming. First, the tubular part 8a1 is press-formed in a first pressing process. By doing so, the roundness of the tubular part 8a1 is determined. Next, in a second pressing process, the upper bulging portions 8e1 and the lower bulging portions 8e2 are formed at a plurality of positions (for example., three positions at 120-degree intervals around the circumference) on the tubular part 8a1. When doing so, a pressing force acts in the radial direction on the tubular part 8a1, which reduces the roundness of the tubular part 8a1 on which the upper bulging portions 8e1 and the lower bulging portions 8e2 have been formed. After this, in a third pressing process, the annular flange portion 8g is press-formed at one end relative to the tubular part 8a1. This third pressing process does not affect the roundness of the tubular part 8a1. Next, in a fourth pressing process, notch parts 8h are formed at a plurality of positions in the circumferential direction (as one example, at three positions at 120-degree intervals in the circumferential direction) in the outer circumferential edge of the annular flange portion 8g. When doing so, machining is performed by applying a pressing force in the axial direction to the annular flange portion 8g, so there is no particular effect on the roundness of the tubular part 8a1. Finally, unnecessary parts are cut off the base material, thereby press-forming the bearing housing 8a that includes the tubular part 8a and the annular flange portion 8g (see FIG. 6A).

As depicted in FIGS. 5A and 5B, the upper end of the housing accommodation part 4e that covers the bearing housing 8a is formed with relief recesses 4g at positions corresponding to the lower bulging portions 8e2. By doing so, the bearing housing 8a in the form of a metal tube that has been press formed is insert-molded into the bottom housing 4b that is made of resin and has the relief recesses 4f formed at positions corresponding to the lower bulging portions 8e2 where the dimension in the radial direction lacks precision. Since the bearing housing 8a mates with a mold die at positions where precision is maintained for the radial dimension, it is possible to suppress the production of resin burrs during insert molding.

Also, as depicted in FIG. 6A, the upper bulging portions 8e1 and the lower bulging portions 8e2 provided on the bearing housing 8a are formed at equally spaced positions around the circumference of the bearing housing 8a (for example, at three positions at 120-degree intervals around the circumference) and at corresponding positions along the axial direction. That is, the upper bulging portions 8e1 and the lower bulging portions 8e2 are formed with the same phase around the circumference of the bearing housing 8a so as to be separated in the axial direction.

By doing so, stress distortion after press machining around the entire circumference of the bearing housing 8a is reduced, and the roundness of the bearing housing 8a in the form of a metal tube can be maintained even after press machining. As a result, the pair of bearings 8b can be concentrically assembled with high precision into the tubular bore 8c of the bearing housing 8a.

Additionally, as depicted in FIG. 6B, the base end of the bearing housing 8a, which is assembled so as to be erected on the bottom housing 4b, is formed with the annular flange 8g whose diameter is larger than the tubular part 8a1. The outer circumferential edge of this annular flange 8g is provided with the notch parts 8h at a plurality of positions around the circumference (as one example, three notch parts 8h at 120-degree intervals in the circumferential direction). When insert molding is performed, the resin of the bottom housing 4b flows into these notch parts 8h.

In this way, the annular flange portion 8g with a larger diameter than the tubular part is formed at the base end of the bearing housing 8a, and since the annular flange portion 8g is press machined in the axial direction to form a plurality of notch parts 8h, the roundness of the inner diameter of the tubular bore of the bearing housing 8a can be maintained. In addition, resin will flow into the plurality of notch parts 8h when the bottom housing 4b is insert molded, which makes it difficult for the bearing housing 8a to become dislodged in the axial direction from the bottom housing 4b after insert molding and also prevents the bearing housing 8a from freely rotating.

As described above, when the bearing housing 8a, which is in the form of a metal tube and produced by press machining, is insert molded into the bottom housing 4b, the bearing housing 8a can mate with the mold die at locations where the precision is maintained for the radial dimension, which suppresses the production of resin burrs during insert molding. Also, since the tubular part 8a1 of the bearing housing 8a, which is a press-machined product, has a high degree of roundness, it is possible to improve the centering accuracy of components such as the pair of bearings 8b that are concentrically assembled into the tubular bore 8c of the bearing housing 8a and the stator assembly that is concentrically assembled on the outer circumference of the bearing housing 8a, which makes it possible to provide a low-cost, high-performance outer rotor type motor.

Although a magnetic pole detection element 6a, such as a Hall IC, is provided on the motor substrate 6 in the embodiment described above, the present invention may be applied to a sensorless DC brushless motor in which a magnetic pole detection element is omitted. The insulator 7 does not have to be integrally molded with the stator core 5a, and may be molded separately and then assembled.

In addition, the number of upper bulging portions 8e1 and lower bulging portions 8e2 provided on the bearing housing 8a may be more than three, and the number of notch parts 8h provided in the annular flange portion 8g may be more or less than three.

What is claimed is:

1. An outer rotor type motor, comprising:
a stator on which stator poles are formed;
a rotor on which rotor poles composed of a permanent magnet are disposed radially outside the stator to face the stator poles;
a rotor shaft whose shaft end portion is integrally assembled with a hub of a rotor yoke, which is cup-shaped;
a bearing housing shaped as a metal tube that is erected on and insert molded into a motor housing made of resin; and
a pair of rolling bearings which are assembled inside the bearing housing and rotatably support the rotor shaft,
wherein the bearing housing is press formed to provide upper bulging portions and lower bulging portions that bulge inward into a tubular bore at a plurality of positions in the circumferential direction, and a tubular part of the motor housing that covers the bearing housing has relief recesses formed at positions corresponding to the lower bulging portions.

2. The outer rotor type motor according to claim 1,
wherein the upper bulging portions and the lower bulging portions are formed along the axial direction at equally spaced positions in the circumferential direction of the bearing housing.

3. The outer rotor type motor according to claim 1,
wherein the bearing housing has a flange portion formed at an end of a tubular housing portion, the flange portion having a larger diameter than the tubular housing portion, and notch parts, into which the resin of the resin motor housing flows, are formed in an outer circumferential edge of the flange portion at a plurality of positions in the circumferential direction.

4. The outer rotor type motor according to claim 2,
wherein the bearing housing has a flange portion formed at an end of a tubular housing portion, the flange portion having a larger diameter than the tubular housing portion, and notch parts, into which the resin of the resin motor housing flows, are formed in an outer circumferential edge of the flange portion at a plurality of positions in the circumferential direction.
